(19) United States
(12) Patent Application Publication
(10) Pub. No.: US 2014/0110030 A1
(43) Pub. Date: Apr. 24, 2014

(54) SELF-INFLATING TIRE

(71) Applicant: Benjamin J. Krempel, Collonge-Bellerive (CH)

(72) Inventor: Benjamin J. Krempel, Collonge-Bellerive (CH)

(21) Appl. No.: 14/123,655

(22) PCT Filed: Jul. 6, 2012
(86) PCT No.: PCT/US12/45640

§ 371 Date: Dec. 3, 2013

Related U.S. Application Data
(60) Provisional application No. 61/571,930, filed on Jul. 8, 2011.
(60) Provisional application No. 61/529,738, filed on Aug. 31, 2011.
(60) Provisional application No. 61/550,583, filed on Oct. 24, 2011.
(60) Provisional application No. 61/589,507, filed on Jan. 23, 2012.

(51) Int. Cl. B60C 29/00

(52) U.S. Cl. CPC B60C 29/00
USPC 152/450

(57) ABSTRACT

A self-inflating inner tube with a pumping mechanism is provided. The self-inflating inner tube employs a non-elastic band that constrains the tube from expanding completely within the tire-rim cavity thereby creating a low pressure zone. The pumping mechanism is placed in the low pressure zone and compresses as load is applied to the section of wheel thereby pushing air into the inner tube. As the wheel rotates the load is removed and the pumping mechanism returns to its original shape drawing in air for the next pumping cycle.

### FIELD OF THE INVENTION

This invention relates self-inflating tires.

### BACKGROUND OF THE INVENTION

There is considerable interest in developing a self-inflating tire. Pneumatic tires require periodic refilling due to changes of temperature, diffusion of air through the rubber materials and air leaks within the system. Previous designs for self-inflating tires can be categorized into different design types. One design uses a piston cylinder (e.g. WO10131383A by Yoshiura and DE4201691A1 by Kell), which works by actuating a small piston that pumps air into the tire's pressure vessel. The deformation of the tire at the contact patch causes the tire piston to move through the cylinder. One problem with this type of design is the resulting bumpy ride, unbalance of the tire and concentration of high wear areas in the tire.

Another design (e.g. DE4201691 by Richter) uses pneumatics to create a system which presses against the inside of the tire and riding surface to utilize the deformation of the tire under load to pump air. This design has a disadvantage of altering tire handling characteristics as the pumping mechanism concentrates force in its area of actuation and probably decreased dampening. It also has a disadvantage of creating three pressure vessels in the tire which must communicate with each other and be regulated to ensure performance.

In yet another design, a mechanical air pump (e.g. US 2009151835 by Manning) is placed in the hub of the tire. Not only is there an additional weight increase, the greatest shortcoming of this design is economic. These designs are typically priced outside of the range of interest of the average users and also require installation by an experienced technician.

In still another design a compressible member is incorporated in the surface of the tire (e.g. US 2009/0044891 by Young Su Lee). As the tire rotates it collapses the band encircling the tire thereby pushing air into the tire through peristalsis. This type of design has a disadvantage of altering road contact characteristics and the pumping mechanism can be prone to puncture.

The present invention addresses at least one or more of these problems by providing a self-pumping (inflating) tire at an economically attractive price.

### SUMMARY OF THE INVENTION

The present invention provides an inner tube with self-inflating functionality. The inner tube further has a means, e.g. a (partial or complete) band around the inner tube, for creating a low pressure region within a tire-rim chamber. Such a band limits the inner tube from expanding completely within the tire-rim chamber. The band could be made of a limited stretch material or a woven material. A pumping mechanism is located in one embodiment at least partially between the inner tube and the riding surface of the tire or in another embodiment at least partially between the rim and the inner tube of the tire. The pumping mechanism could be constructed of thin film materials or open-cell foam. In one embodiment, one or more guides are used to optimize the opening and closing of the pumping mechanism. A valve control system is provided that directs air from the pumping mechanism into the inner tube. It contains one or more one-way valves and the pressure is infinitely adjustable through a range of 0-16 bar. In one example, the pressure can be toggled between 2 or more discreet pressures. In another example, the pressure setting can be adjusted by remote means.

### BRIEF DESCRIPTION OF THE DRAWINGS

FIG. 1 shows an exploded view according an exemplary embodiment of the present invention. 1=inner tube, 2=pumping mechanism, 3=guide, and 4=rim.

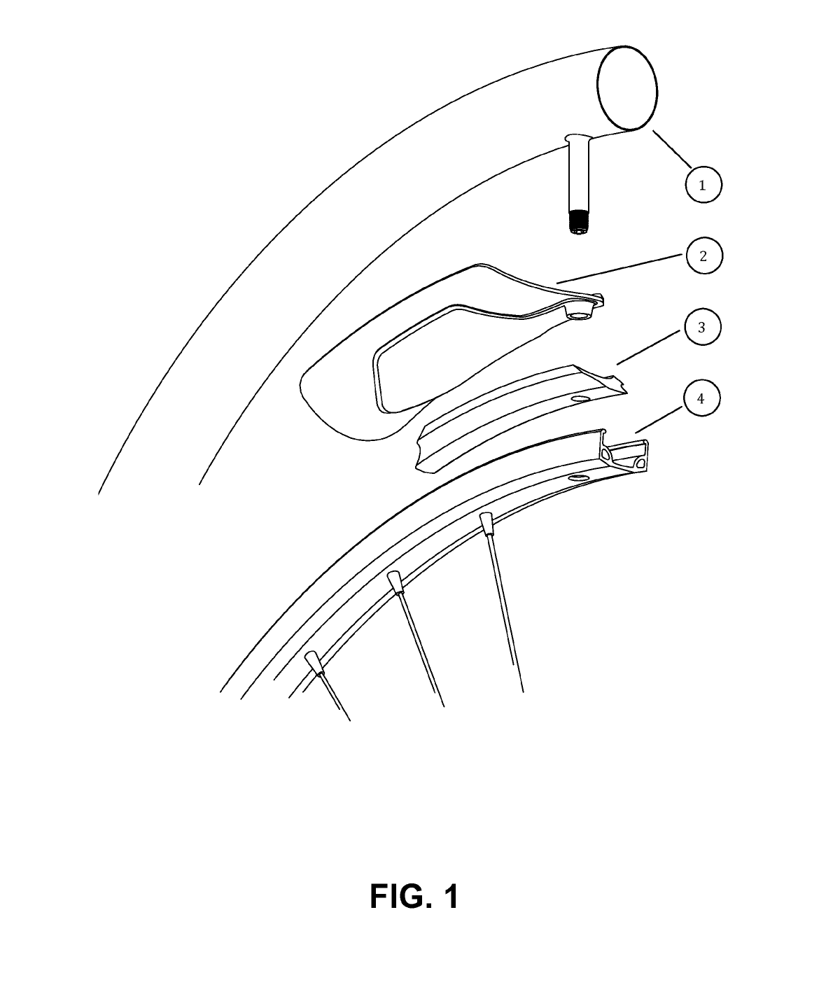

FIG. 2 shows a cross section of a rim according an exemplary embodiment of the present invention.

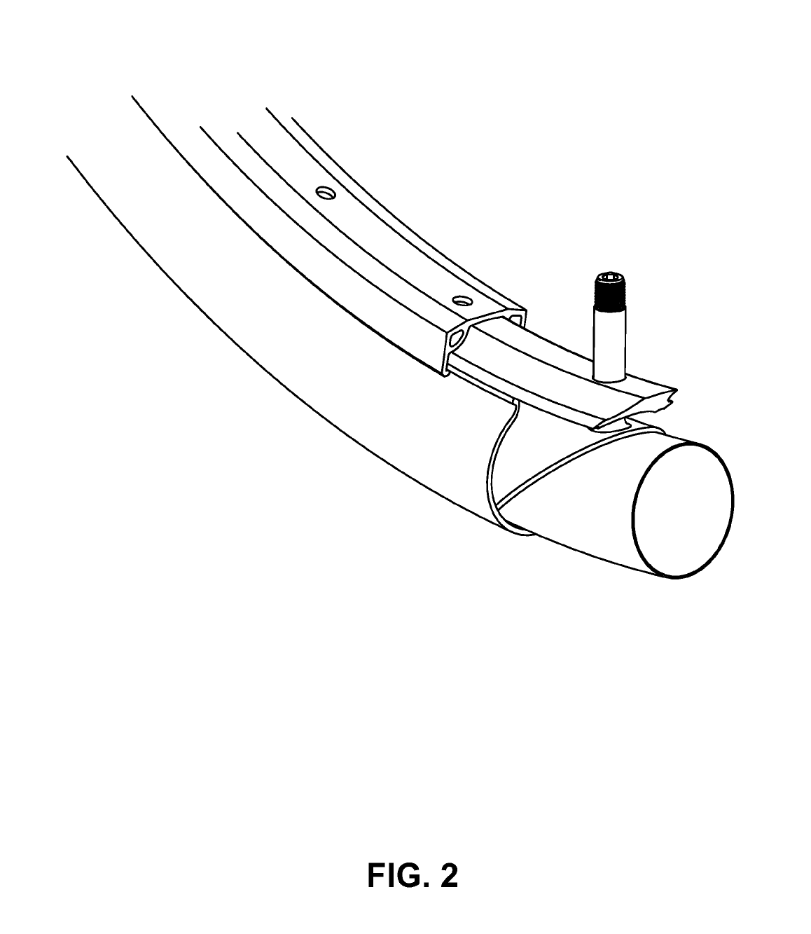

FIGS. 3A-B shows a side-by-side view A and B showing deformation of a cavity according an exemplary embodiment of the present invention.

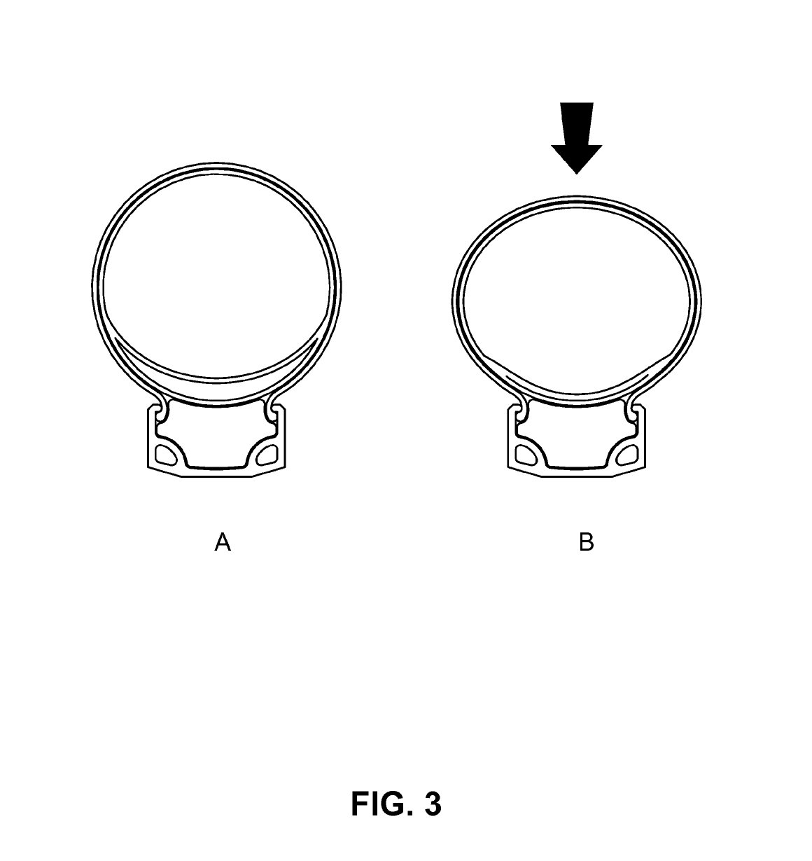

FIGS. 4A-C show different views A-C of a pumping mechanism with non-elastic band according an exemplary embodiment of the present invention. 5=band, 6=pumping mechanism, and 7=pneumatic connector to inner tube.

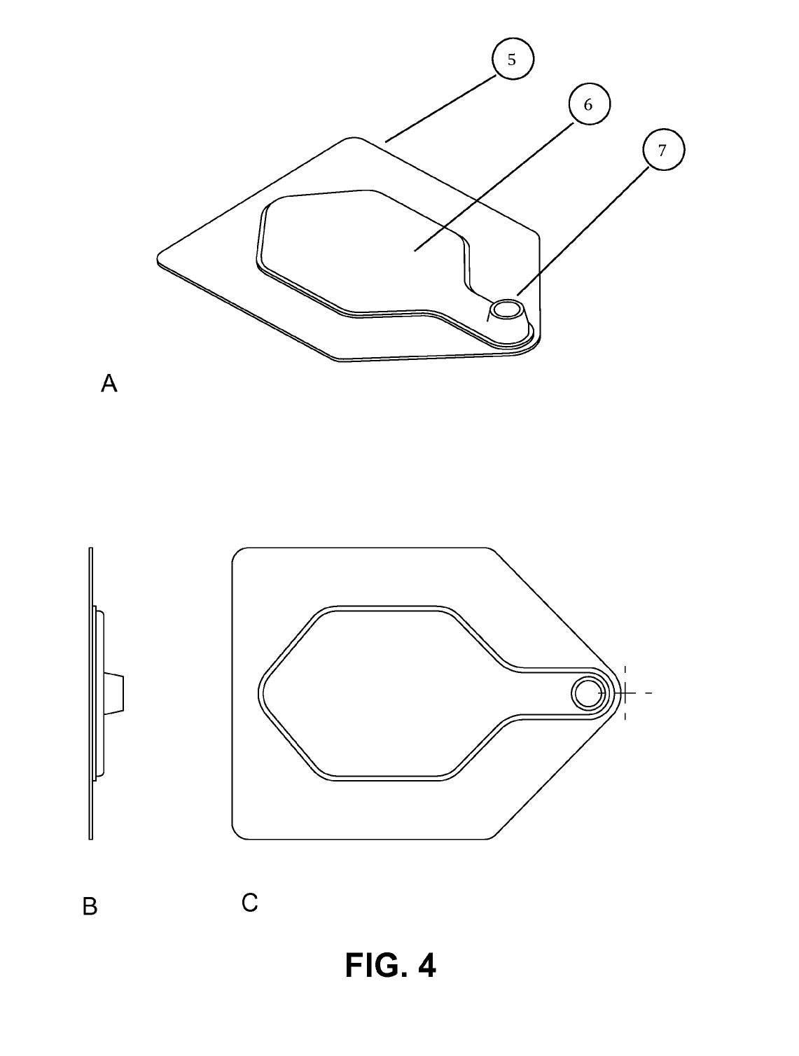

FIG. 5 shows a schematic 1 according an exemplary embodiment of the present invention.

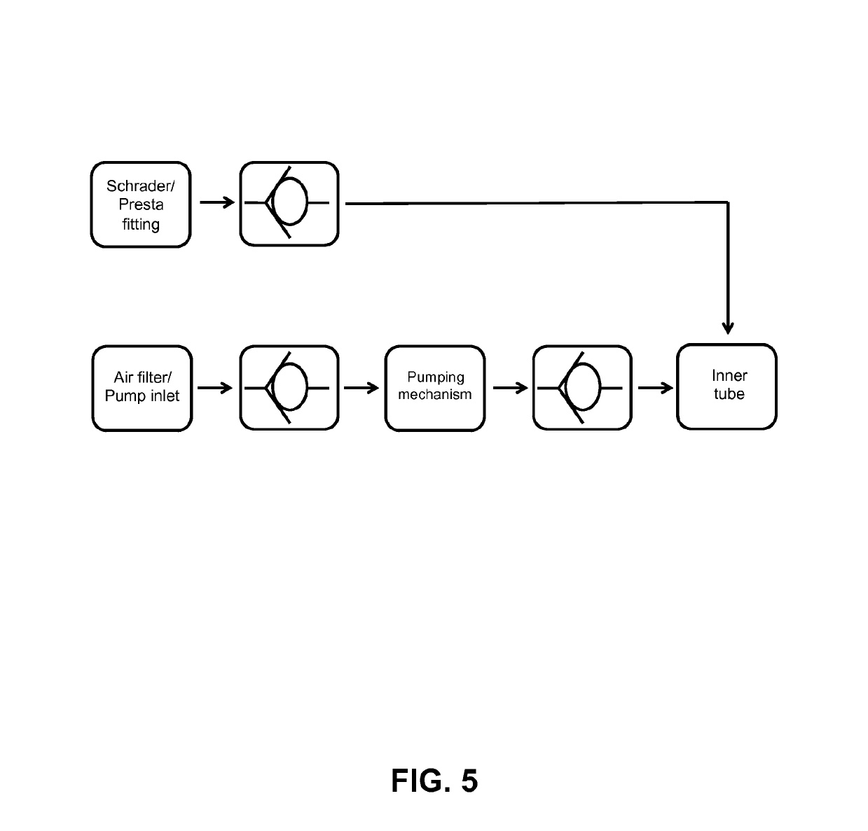

FIG. 6 shows a schematic 2 according an exemplary embodiment of the present invention.

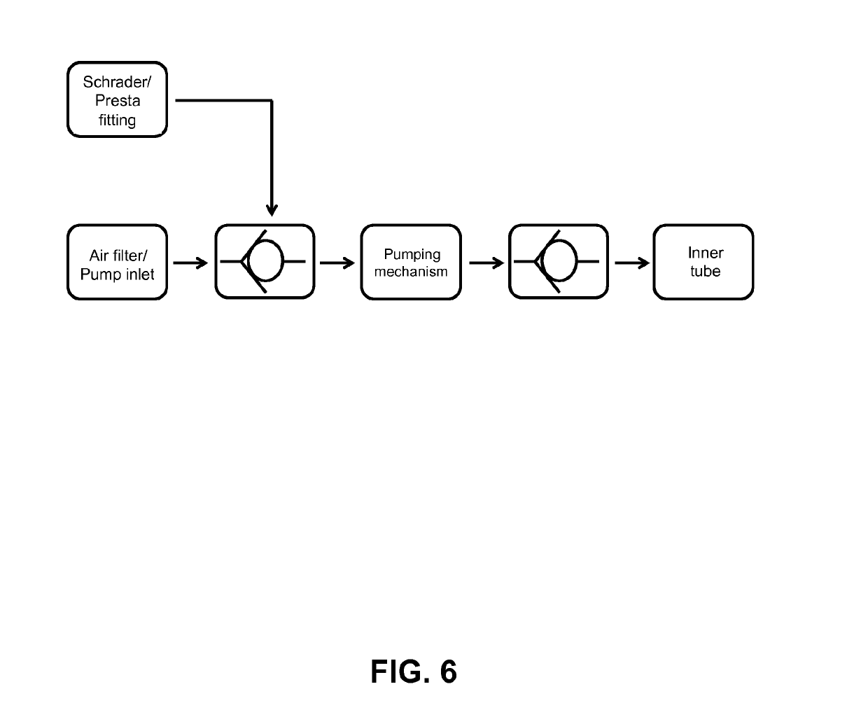

FIG. 7 shows the pumping mechanism according an exemplary embodiment of the present invention.

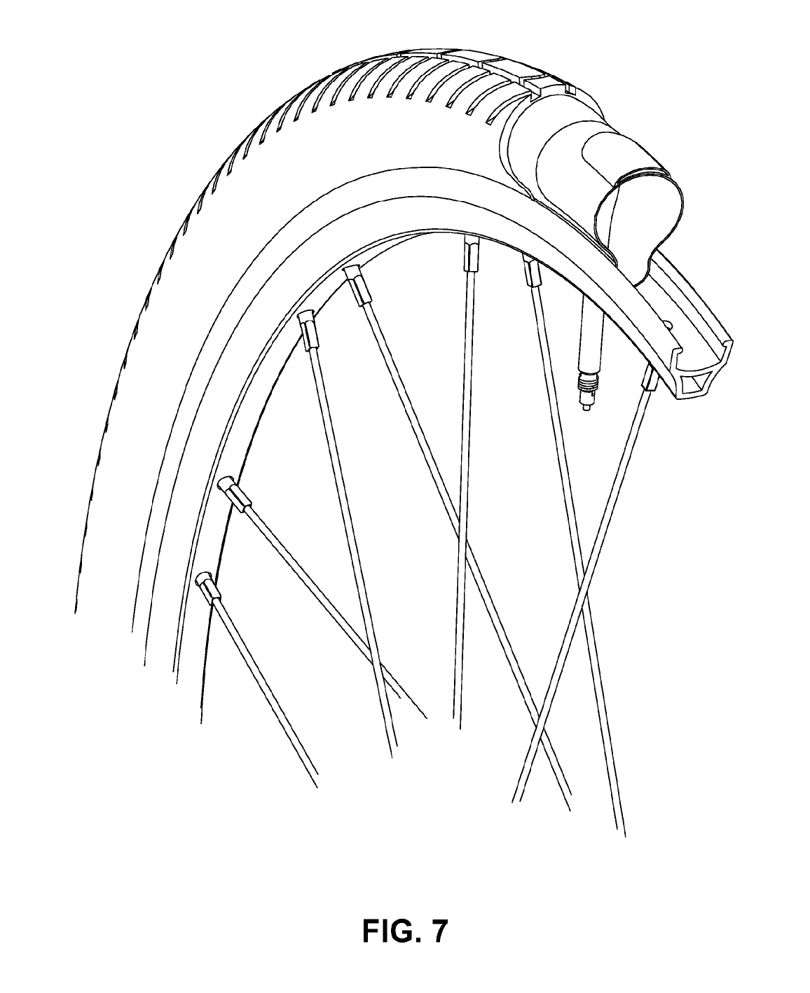

### DETAILED DESCRIPTION

The design for a self-inflating inner tube incorporates a pumping mechanism into the inner tube, enabling the technology to be used with the array of existing tires already on the market. An inner tube is usually defined by two numbers such as 700 mm×35 mm. The 700 mm refers the diameter of the defining circle and the 35 mm refers to the diameter of the tube. The invention uses a band with limited stretch that wraps around the tube. The band stops the tube from expanding to the full area of the tire-rim chamber. In one embodiment the band wraps completely around a region of the tube and is attached to itself. In another embodiment the band wraps completely around the entire tube diameter and the complete perimeter of the defining circle. The band may be attached by adhesive, welding, ultrasonic welding, RF welding or any other process. In another embodiment the band wraps partially around the tube in at least one region with the band attaching in one or more places to the tire-rim chamber. This creates the same effect of limiting the expansion of the tube and creates a low pressure zone where the pump can be located. The band may be made from woven materials or fabrics. It may also be made from non-woven materials. The band may be made from PVC, PE, PU, thermoplastic elastomers (TPEs), ethylene vinyl acetate (EVA), polyolefins (polyethylene/polypropylene), metallocenes, nylon, rubber, aramids, Kevlar, GoreTex, cotton, Teflon, mylar, aluminum, metal, fiberglass, carbon fiber or any other material or combination of materials. A working model of the band was created using TPU laminated nylon 70D fabric with a polyester base manufactured by China-based International Holdings Ltd. The material was wrapped around the tube with 10 mm of material overlap along its length. It was heat staked to form a band using temperatures of 250-300 degrees C. and Teflon sheets to inhibit sticking. The band may have a constant diameter or differing diameters. In one embodiment it is desirable to have an hourglass design where the end diameters of the band expand to the full diameter of the tire-rim chamber. The embodiment may have a constant diameter region where the pumping mechanism is located. The embodiment may have a variable diameter region that conforms to a non-symmetrical or irregular shape of the pumping mechanism. The pumping mechanism can be a button type pump with a circular, tear-shaped, oval, elliptical, square, rectangular, trapezoidal, triangular or any other geometric shape or combination of shapes. The pumping mechanism can also be tubular in nature and work like a peristaltic pump. The pumping mechanism may completely surround the tube. The pumping mechanism may be located anywhere around the perimeter of the tube and the defining circle of the inner tube. The pumping mechanism may be located in just one small area of the defining circle of the inner tube or it may extend along the entire perimeter of the defining circle. The pumping mechanism is ideally constructed from flexible, thin film materials including PVC, PE, PU, thermoplastic elastomers (TPEs), ethylene vinyl acetate (EVA), polyolefins (polyethylene/polypropylene), metallocenes, nylon, rubber, foam, woven fabric, aramids, Kevlar, GoreTex, cotton, Teflon, mylar, aluminum, fiberglass, carbon fiber or any other material or combination of materials that allow it to flex. In one case the pumping mechanism works by encasing open-cell foam or other materials capable of generating spring force in a thin film housing to draw air in from the atmosphere. In a working example open-cell foam SRT Gray and Regicell 80 Black was supplied by Foam Partners located in Wolfhausen, Switzerland. The open-cell foam was RF welded between thin film PVC to create the pumping mechanism. The pumping mechanism may have a single chamber or multiple chambers. In multiple chamber versions, the chambers may act in parallel, in series or a combination thereof. The pumping mechanism may also have inert chambers or structures which are not pneumatically connected to the air flow circuit. The inert chambers may be used to alter the flow of air through expansion or compression or shape the tube in the constrained area. They may be isolated from each other or connected to each other. The inert chambers may be sealed or may be open to the atmosphere. They can be made of thin film PVC, PE, UR, thermoplastic elastomers (TPEs), ethylene vinyl acetate (EVA), polyolefins (polyethylene/polypropylene), metallocenes, open-cell foam, closed-cell foam, rubber plastic or any other material. They may also be used to change the outward profile or shape of the tire. The pumping mechanism works by drawing in air from the atmosphere into the pumping mechanism and pushing it into the inner tube. As the tire roles through the contact patch with the riding surface, the pumping mechanism is compressed between the inner tube and the tire-rim chamber. The pumping mechanism may work by completely compressing or it may work by only partially compressing. The load is transferred from the tire to the inner tube to the pumping mechanism and finally to the rim. The pumping mechanism may also be located at least partially between the tire and the inner tube whereby the force is transferred from the tire to the pumping mechanism to the inner tube and then to the rim. In one embodiment the pumping mechanism is placed away from the rim so that it compresses flat against the riding surface with each rotation. In another embodiment the pumping mechanism is located closer to the rim or at least for it to be in pneumatic communication with the area near the rim to avoid the need for an air conduit from the valve stem to the pumping mechanism. There may also be intermediary materials between each of the surfaces to act as guides, provide anti-puncture benefits, anti-friction or other beneficial properties. The intermediary materials may also provide rigidity or direct forces through the assembly to achieve higher pumping pressures.

As the pumping mechanism flattens, the compressed air is then pushed into the inner tube. Once the load is removed from the pumping mechanism, spring force brings the pumping mechanism back to its original shape thereby drawing in air for the next pumping cycle. The spring force required for the pumping mechanism can be provided by the design of the surrounding materials, the use of open-cell foam, closed-cell foam, coil springs, leaf spring or other structures. The design lends itself to lightweight spring materials such as plastic; however, it could also employ PVC, PU, PE, thermoplastic elastomers (TPEs), ethylene vinyl acetate (EVA), polyolefins (polyethylene/polypropylene), metallocenes, nylon, rubber, metal, aluminum, iron, steel, air bladders, compressed air, brass, silicon, synthetic rubber, natural rubber or any other type of elastic material. One design incorporates a thin film pumping mechanism with integrated thin film 1-way valves and open-cell foam to create the pumping mechanism.

The invention may also use a guide to further shape the compression of the pumping mechanism. For example the guide can be shaped to make the compression surface concave, convex, flat, textured or any other shape. The guide can provide rigidity to the compression surfaces of the rim, pumping mechanism or inner tube to enable the system to reach higher pressures. The guide can be located anywhere within the tire-rim chamber to enable the pumping mechanism to operate more efficiently. The guide can be one, two or more pieces. In one embodiment the guide is located between the rim and the pumping mechanism to create an enhanced compression surface for the pumping mechanism. In another embodiment the guide is located on the inner tube. In one embodiment the guide is its own pressure vessel and a storage reservoir for compressed air. The guide may be located in just one part of the tire or the guide may completely encircle the tire. The guide can be constructed of PVC, PU, PE, thermoplastic elastomers (TPEs), ethylene vinyl acetate (EVA), polyolefins (polyethylene/polypropylene), metallocenes, nylon, rubber, metal, aluminum, iron, steel, air bladders, compressed air, brass, silicon, synthetic rubber, natural rubber or any other type of material.

Designs of the invention use valves to regulate air through the air flow circuit. In one embodiment a check valve allows air to be pushed from the pumping mechanism into the inner tube. A second check valve stops air from flowing backwards into the valve stem when the pumping mechanism is being compressed. Air enters the pumping mechanism from the valve stem. The valve stem works similar to a conventional valve stem, but with the added functionality of allowing air to enter the pumping mechanism. The valves may be located anywhere in the system that is most convenient. For example the some or all of the valves could be located in the valve stem, guide, pumping mechanism or in the inner tube itself. The valves may also be releasably attached to the invention so they can be changed or replaced by the user. In one embodiment, part of the valve is located in the valve stem which can be unscrewed from the rest of the product. This allows the user to change the valve and air handling characteristics without having to remove the inner tube from the wheel.

In addition to the self-inflating feature, air can also be added to the system via the valve stem. The valve stem may use a Presta, Schrader or any other type of connection method. When compressed air is pushed into the inner tube from an air pump or with compressed air, it may go directly into the inner tube. In this embodiment, there is an air pathway that leads from the valve stem directly to the inner tube and a parallel pathway from the air stem to the pumping mechanism. Compressed air may also enter the inner tube from a single in series pathway by which the air enters the valve stem is directed to the pumping mechanism and then pushed in to the inner tube. The invention also employs an air filter which may be located external to the system such as on the valve stem. It may employ an internal filter which is located inside the valve stem. In one embodiment a removable, external air filter constructed of open-cell foam is placed around the perimeter of the valve stem. In another embodiment an internal air filter is located inside of the valve stem and is screwed onto the valve stem.

With an automated system it is important to have a means for limiting the amount of pressure that builds up in the system. There are several ways this can be done. In one embodiment the system reaches a terminal or maximum pressure for a given load where the pumping mechanism cannot overcome the pressure in the inner tube and the system stops pumping. The terminal pressure is influenced by pump size, pump shape, expected load, stiffness in the surrounding materials and other factors. This is in some respects a control-less system. The system stops pumping air into the inner tube once the maximum pressure in the inner tube is equal to the maximum pumping pressure of the pumping mechanism. This control mechanism has the additional benefit that the terminal pumping pressure in the system increases as load increases. This is beneficial as it optimizes the contact patch, ride comfort, tire deformation for the load for the specific load on the tire rather than stopping at a specific pressure setting such as 4 bar. Another means employs a control circuit that closes the air pathway once the set pressure has been reached. The air pathway may be closed anywhere along the circuit. It may be closed before the pumping mechanism, in which case the pumping mechanism would remain flat at the set pressure. It may be closed after the pumping mechanism in which case the pumping mechanism would remain pressurized. The control circuit may be pneumatic, mechanical, electronic, pressure driven or use any other means to operate. The invention may also employ a pressure release valve which discharges pressure should the pressure in the inner tube exceeds a specific set point.

In another embodiment the inner tube pressure can be quickly toggled between two predetermined pressure settings P1 and P2. Each pressure settings may be fixed or user-adjustable. The invention is particularly useful in applications such as mountain biking where it is desirable to use a lower pressure setting for increased traction through higher rolling resistance under certain conditions and higher pressure settings for increased speed through lower rolling resistance. In one embodiment of the invention, P1 is fixed at 3 bar and P2 is fixed at 4.5 bar. In another embodiment P1 is 0 bar and P2 is 15 bar. A rider may start at P1 during the ride then toggle the switch to set the pressure to P2. The system then pumps until P2 is reached. At another point in time the rider may toggle the pressure back to P1 whereupon the system releases pressure until P1 is reached. The pressure maybe be released immediately through design of the control system or the pressure may be released gradually through diffusion. The control system may be configured to be infinitely variable between the P1 and P2 pressure settings.

The invention may use a valve stem cap or attachment that uses air pressure to create mechanical motion resulting in spinning, bobbing, noise or other motion. The motion may be a warning indicator or simply for aesthetic pleasure. The motion may be silent or noise producing. The noise may be a whistle, hum, buzz, bell, click, horn or any other noise. The noise may be continuous or intermittent. The noise may be activated within a set pressure range to indicate specific conditions. The noise may be used to indicate low pressure, when the pump is pumping, when the pressure reaches a desired level or the pressure has exceeded a desired level or other set points. In one instance a pressure gauge is attached to the valve stem.

The pumping system may also be used to power a device, a projectile or fluid. The fluid pumping system may be a water gun or squirt gun. It may be used for disbursing a liquid such as paint, oil or any other fluid. It may be used for disbursing a solid such as fertilizer, grains, paintballs or any other object. In one embodiment the invention uses escaping air pressure from the inner tube to generate electricity. The means may be a small turbo, fan or other air powered engine that rotates a generator to produce electricity.

The invention may employ a system for controlling the air pressure and monitoring other data in the tire by remote means. The means can be pneumatic, electric, electronic, mechanical, wireless, permanently fixed linkage or removable linkage. The means may control a single tire or multiple tires on a vehicle thereby acting as a central air manifold pressure control. The pressure in the tires may be controlled as a group or individually. The pressure may be controlled while the wheel is in motion. In one embodiment the wheel has a ratcheting, turning motion that can be set to a new position as the wheel passes by a fixed spot. For example, a device similar to a brake caliper can be used to approach the ratcheting means thereby changing the position. The position can be changed by mechanical, magnetic, electromechanical or any other means. The control means may be located on the vehicle or in a location not on the vehicle. In another embodiment the valve stem extends to the hub of the tire and is attached to a rotating coupler. The rotating coupler allows the portion attached to the wheel to rotate and another portion to be fixed in place on the vehicle. The rotating coupler would be similar in design to the rotating couplers currently being used for automatic tire inflation systems in the automotive field. The remote control pressure means allows a valve or control mechanism to be located or operated from any location in the system. The data communicated may include a pressure sensor located in or on the wheel. The communication means may be used to alter settings on the tire or tires including air pressure, temperature and tire profile.

The invention may employ a pressure control algorithm whereby pressure in the tire can be programmed to be automatically adjusted by taking variables such at speed, rpm, slipping forces, temperature, weight, tire deformation and other variables into account. The algorithm can be computer controlled, pneumatic or mechanically controlled.

The invention may use of a snorkel or extended valve stem to limit the entry of water or other foreign bodies into the inner tube. The invention may use of an inlet valve that allows air to enter but stops water from entering.

The invention may also employ an additional pressure vessel that is incorporated on the vehicle to avoid the need to carry an air pump. In the case of a flat tire, the rider could change the tire and then connect a tube from the refillable pressure vessel to the new tire to inflate it. The invention offers a weight savings and time savings compared to using a hand pump. In addition, the invention could also be used in combination with self-inflating tires to create a system that is always ready and capable of inflating multiple tires. The invention may include one or more refillable pressure vessels on the same vehicle. The refillable pressure vessel may be mounted on the vehicle, in the frame, in the seat, in the forks, in the wheel. The refillable pressure vessel may be located with the tire-rim cavity. The refillable pressure vessel may be integrated into any component on the vehicle so that very little if any additional weight is added to the vehicle. The air in the refillable pressure vessel may be regulated directly or through the use of a vehicle, tire, frame mounted system. The refillable pressure vessel may comprise a maximum pressure shut-off or release that limits the amount of pressure in the vessel. The refillable pressure vessel may be constructed of plastic, PVC, PU, PE, thermoplastic elastomers (TPEs), ethylene vinyl acetate (EVA), polyolefins (polyethylene/polypropylene), metallocenes, nylon, fiberglass, resin, aluminum, titanium, steel, metal or any other material that is currently used to create vehicle frames and their components. The refillable pressure vessel may be configured on the vehicle to be in pneumatic contact with at least one of the tires during normal vehicle operation. This would be accomplished by connecting a tube means between the refillable pressure vessel and the tire. A rotating junction enables the pressure to be communicated between the vehicle and the rotating tire, similar to rotating junctions currently being used on self-inflating automotive tire applications. There may be multiple refillable pressure vessels on a single vehicle to permit multiple pressures to coexist. The refillable pressure vessel may be pneumatically connected to a device that does work or generates electricity. Devices that do work include, but are not limited to liquid and solid projectile devices, rotors, turbines, heaters, refrigerators, inflation devices. The refillable pressure vessel may include a gauge to communicate pressure, temperature or other relevant information about the system. The gauge may be pneumatic, mechanical or electrical and the energy powering the gauge may be generated by the refillable pressure vessel itself or the energy may come from a different source.

Embodiments of the invention have application in any wheel using an inner tube including bicycles, wheelchairs, hand trucks, strollers, trailers, off road vehicles, automobiles, motorcycles, airplanes and any other application.

What is claimed is:

1. A self-inflating inner tube in a tire, comprising:
(a) an inner tube having a non-elastic band for constraining said inner tube from expanding beyond a threshold for said inner tube within a tire-rim chamber, whereby said non-elastic band creates a lower pressure zone for said inner tube compared to the rest of said inner tube; and
(b) a pumping mechanism near said non-elastic band and in said lower pressure zone, wherein said pumping mechanism draws air from the atmosphere into chambers of said pumping mechanism when said pumping mechanism is in a non-compressed state during a rotating cycle of said tire, and pumps said drawn atmospheric air from said chambers into said inner tube when said pumping is in a compressed state when load is applied to said lower pressure zone during said rotating cycle of said tire, thereby self-inflating said inner tube.

2. The self-inflating inner tube as set forth in claim 1, further comprising a valve control mechanism for directing said drawn atmospheric air from said pumping mechanism into said inner tube.

3. The self-inflating inner tube as set forth in claim 2, wherein a pressure setting for said valve control mechanism can be adjusted remotely.

4. The self-inflating inner tube as set forth in claim 2, wherein a pressure setting for said valve control mechanism can be toggled by a user using discrete pressures.

5. The self-inflating inner tube as set forth in claim 1, wherein said chambers of said pumping mechanism are made out of thin-film material.

6. The self-inflating inner tube as set forth in claim 1, wherein said chambers of said pumping mechanism are made out of open-cell foam material.
